(19) United States
(12) Patent Application Publication
(10) Pub. No.: US 2026/0236227 A1
(43) Pub. Date: Aug. 13, 2026

(54) FULL ADDER AND FULL ADDER TREES IMPLEMENTING NEGATIVE OUTPUTS

(71) Applicant: Taiwan Semiconductor Manufacturing Company, Ltd., Hsinchu (TW)

(72) Inventors: Haruki Mori, Hsinchu (TW); Hidehiro Fujiwara, Hsinchu (TW); Je-Min Hung, Hsinchu (TW)

(73) Assignee: Taiwan Semiconductor Manufacturing Company, Ltd., Hsinchu (TW)

(21) Appl. No.: 19/227,070

(22) Filed: Jun. 3, 2025

Related U.S. Application Data
(60) Provisional application No. 63/757,989, filed on Feb. 13, 2025.

(51) Int. Cl. G06F 7/501; G06F 7/53; G06F 7/544

(52) U.S. Cl. CPC G06F 7/501; G06F 7/5318; G06F 7/5443

(57) ABSTRACT

Full adder devices, circuits, and a method of operating the same are disclosed. In one aspect, an adder tree device can include a first adder circuit configured to receive a first operand and a second operand as input and generate a negative sum value, wherein the negative sum value is a logical inversion of a sum of the first operand and the second operand. The adder tree device can further include a second adder circuit configured to receive the negative sum value and an additional operand as input and generate a positive sum value as output. The positive sum value can be equal to the sum of the first operand and the second operand plus a logical inversion of the additional operand.

This application claims priority to and the benefit of U.S. Provisional Application No. 63/757,989, filed Feb. 13, 2025, the content of which is incorporated herein by reference in its entirety for all purposes.

### BACKGROUND

The semiconductor industry has experienced rapid growth due to continuous improvements in the integration density of a variety of electronic components (e.g., transistors, diodes, resistors, capacitors, etc.). For the most part, this improvement in integration density has come from repeated reductions in minimum feature size, which allows more components to be integrated into a given area.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 illustrates a diagram of an example circuit implementing a full adder with inverted outputs, in accordance with some embodiments.

FIG. 2 illustrates a diagram of an example adder tree circuit including full adder circuits with negative sum outputs and negative carry outputs, in accordance with some embodiments.

FIG. 3 illustrates a diagram of an example adder tree circuit including full adder circuits with negative sum outputs and positive carry outputs, in accordance with some embodiments.

FIG. 4 illustrates a diagram of an example adder tree circuit including full adder circuits with positive sum outputs and negative carry outputs, in accordance with some embodiments.

FIG. 5 illustrates a diagram of an example multiply-accumulate (MAC) circuit that can implement one or more of the adder tree circuits described in connection with FIGS. 2, 3, and 4, in accordance with some embodiments.

FIG. 6 illustrates a diagram of a portion of a multiplier circuit that can be included in the MAC circuit described in connection with FIG. 5, in accordance with some embodiments.

FIG. 7 illustrates a diagram of an example adder tree circuit, which may encompass one or more of the adder tree circuits of the MAC circuit described in connection with FIG. 5, in accordance with some embodiments.

FIG. 8 illustrates a diagram of an example two-stage adder tree circuit including full adder circuits with negative sum outputs and negative carry outputs, in accordance with some embodiments.

FIG. 9 illustrates a flowchart of an example method of operating one or more of the adder circuits described herein, in accordance with some embodiments. in accordance with some embodiments.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” “top,” “bottom” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

Digital compute-in-memory (DCIM) circuits reduce memory movement and improve computational efficiency for various computational operations, such as matrix-matrix operations, by executing compute operations within or adjacent to memory elements. One example of operations that may be performed in DCIM circuits are multiply-accumulate (MAC) operations, which useful for applications such as neural network inference or scientific computing. In conventional DCIM implementations, MAC operations consume significant power, with multiplier circuits and adder trees accounting for over seventy-five percent of total power consumption. Adder cells, including half-adder and full-adder (FA) cells, make up most of the components of both multipliers and adder trees, contributing substantially to dynamic power due to frequent state transitions and buffer operations within their logic paths. Conventional adder circuits employ output buffers in both sum and carry directions to maintain signal integrity and polarity consistency across computational stages. However, these buffers introduce additional capacitance and switching activity, increasing power consumption without commensurate performance gains.

The techniques described herein introduce FA circuit topologies that modify output polarities of sum and carry paths to reduce power consumption in DCIM adder trees. These techniques eliminate or reconfigure output buffers in FA cells based on predefined polarity configurations, thereby minimizing unnecessary switching activity. The techniques described herein can be used to implement adder tree having a variety of configurations, including configurations including only FA cells with negative outputs for both sum and carry paths, configurations including FA cells with a negative sum output and positive carry output, and configurations including FA cells with a positive sum output and negative carry output. In some implementations, one or more of such configurations can be combined to implement a variety of different adder trees, as described in further detail herein. The techniques described herein can significantly reduce power consumption in DCIM MAC operations compared to circuits implementing conventional FA circuits.

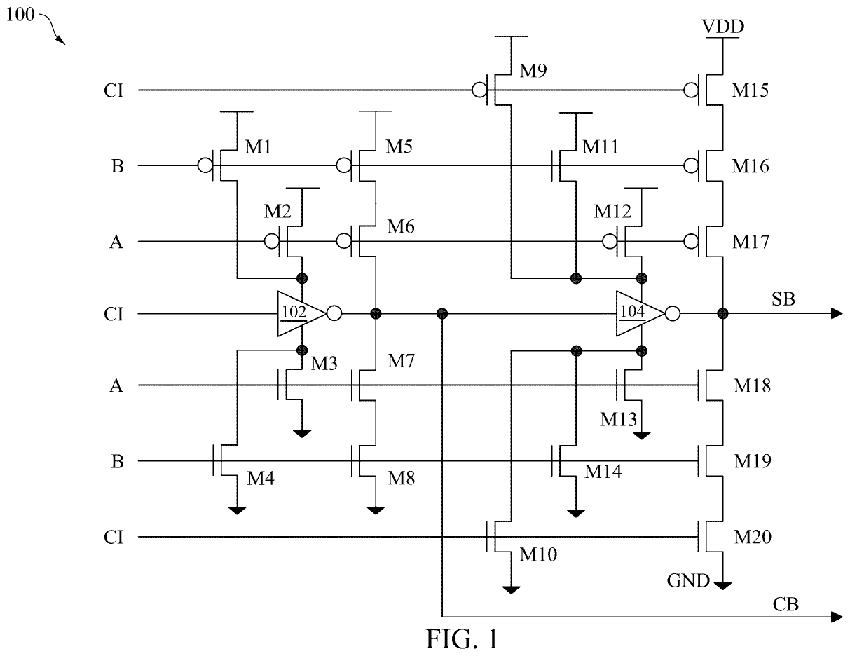

Referring to FIG. 1, illustrated is an example full adder circuit 100, in accordance with some embodiments. Each of the components shown in the full adder circuit 100 may receive power from one or more voltage sources such as the supply voltage VDD. The full adder circuit 100 may include one or more logic gates and sub-circuits, each of which may be constructed from one or more logic gates. Logic gates are electronic devices that perform logical operations on one or more input signals to produce a single output signal.

Various embodiments of the circuits and logic gates that implement the full adder circuit 100 may include various transistors. The transistors described herein may have a certain type (n-type or p-type), but embodiments are not limited thereto. The transistors can be any suitable type of transistor including, but not limited to, metal oxide semiconductor field effect transistors (MOSFET), complementary metal oxide semiconductors (CMOS) transistors, P-channel metal-oxide semiconductors (PMOS), N-channel metal-oxide semiconductors (NMOS), bipolar junction transistors (BJT), high voltage transistors, high frequency transistors, P-channel and/or N-channel field effect transistors (PFETs/NFETs), FinFETs, planar MOS transistors with raised source/drains, nanosheet FETs, nanowire FETs, or the like. It should be understood that the full adder circuit 100 shown in FIG. 1 can be a portion of a DCIM circuit, a MAC circuit, an adder tree circuit, or any other type of circuit implementing adder operations. In some implementations, the full adder circuit 100 may be included in one or more memory circuits. The full adder circuit 100 is shown as including the transistors M1, M2, M3, M4, M5, M6, M7, M8, M9, M10, M11, M12, M13, M14, M15, M16, M17, M18, M19, and M20. The full adder circuit 100 is shown as including a first inverter 102 and a second inverter 104.

Although each of the transistors M1-M20 of the full adder circuit 100 are shown as one transistor, embodiments are not limited thereto. For example, each of the transistors can include multiple transistors (“sub-transistor(s)”) that are connected to one another in parallel. For example, each of the sub-transistors of any transistor described herein can include respective gate, drain, and source terminals, each of which can be connected to one another in parallel. Each of the transistors M1-M20 includes a gate terminal, a first source/drain terminal, and a second source/drain terminal. The transistors M1, M2, M5, M6, M9, M11, M12, M15, M16, M17 are shown as p-type MOSFET transistors. The transistors M3, M4, M7, M8, M10, M13, M14, M18, M19, M20 are shown as n-type MOSFET transistors. In some implementations, the transistors M1-M20 can include other types, such as bipolar junction transistors or high-electron-mobility transistors, while remaining within the scope of the present disclosure.

The gate terminals of the transistors M2, M3, M6, M7, M12, M13, M17, and M18 are shown as coupled to the first input operand A. The gate terminals of the transistors M1, M4, M8, M5, M11, M14, M16, and M19 are shown as coupled to the second input operand B. The gate terminals of the transistors M9, M15, M10, and M20 are coupled to the carry input CI. The gate terminals of the transistors M1 through M20 are configured to receive respective input signals for controlling the conduction state of the transistors.

The first source/drain terminals of the transistors M1, M2, M5, M9, M11, M12, and M15 are coupled to the supply voltage VDD. The second source/drain terminals of the transistors M3, M4, M8, M10, M13, M14, and M20 are coupled to the ground voltage. The second source/drain terminal of the transistor M1 is coupled to the power terminal of the first inverter 102. The second source/drain terminal of the transistor M2 is also coupled to the power terminal of the first inverter 102. The first source/drain terminals of the transistors M3 and M4 are coupled to the ground terminal of the first inverter 102.

The second source/drain terminal of the transistor M5 is coupled to the first source/drain terminal of the transistor M6. The second source/drain terminal of the transistor M6 is coupled to the output of the first inverter 102, the first source/drain terminal of the transistor M7, and the input of the second inverter 104. The second source/drain terminal of the transistor M7 is coupled to the first source/drain terminal of the transistor M8. The second source/drain terminals of the transistors M9, M11, and M12 are coupled to the power terminal of the second inverter 104. The first source/drain terminals of the transistors M10, M13, and M14 are coupled to the ground terminal of the second inverter 104.

The second source/drain terminal of the transistor M16 is coupled to the first source/drain terminal of the transistor M17. The second source/drain terminal of the transistor M17 is coupled to the output of the second inverter 104. The first source/drain terminal of the transistor M18 is coupled to the output of the second inverter 104. The first source/drain terminal of the transistor M19 is coupled to the second source/drain terminal of the transistor M18. The first source/drain terminal of the transistor M20 is coupled to the second source/drain terminal of the transistor M19. The negative carry output CB of the full adder circuit 100 is provided at the output of the first inverter 102 and the negative sum output SB of the full adder circuit 100 is provided at the output of the second inverter 104.

During operation of the full adder circuit 100, when the first input operand A is in a logic low state, the second input operand B is in a logic low state, and the carry input CI is in a logic low state, the transistors M2, M6, M12, M17 are turned on, since their gates are coupled to the first input operand Ain the logic low state. Likewise, the transistors M1, M5, M11, M16 are turned on, since their gates are coupled to the second input operand B in the logic low state. Additionally, the n-type transistors M3, M7, M13, M18 are turned off and the transistors M4, M8, M14, M19 are turned on. The transistors M9 and M15 are turned on and conduct and the transistors M10 and M20 are turned off, since their gates coupled to the carry input CI.

In these states, the power terminal of the first inverter 102 is connected to the supply voltage VDD via the turned-on transistors M1 and M2. The ground terminal of the first inverter 102 is disconnected from ground due to the turned-off transistors M3 and M4. The input of the first inverter 102 is in the ground state, according to the carry input CI. This causes the output of the first inverter 102 to be in a logic high state, providing the negative carry output CB in the logic high state, which is the inversion (e.g., negative output) of the actual carry value of “0”. Additionally, because the transistors M5 and M6 are turned on while the transistors M7 and M8 are turned off, the node connected to the carry output CB and the input of the second inverter 104 is pulled to the logic high state.

Additionally, in these input states, the power terminal of the second inverter 104 is connected to the supply voltage VDD due to the turned-on transistors M9, M11, and M12. The ground terminal of the second inverter 104 is disconnected from ground via the turned-off transistors M10, M13, and M14. The output node of the second inverter, and the negative sum output SB of the circuit, is pulled to a logic high state (e.g., the logical inversion of the actual sum value of “0”). Because the second inverter 104 is disconnected from ground, the output of the second inverter 104 is a floating output (e.g., not pulled to ground). However, because the transistors M15, M16, and M17 are turned on and conducting, while the transistors M18, M19, and M20 are turned off, the negative sum output is pulled to the logic high state.

In another example, when the first input operand A is in a logic high state, the second input operand B is in a logic high state, and the carry input CI is in a logic high state, the transistors M3, M7, M13, and M18 are turned on, since their gates are coupled to the first input operand A in the logic high state. The transistors M4, M8, M14, and M19 are also turned on, since their gates are coupled to the second input operand B in the logic high state. Additionally, the transistors M10 and M20 are turned on and the transistors M9 and M15 are turned off, since their gates coupled to the carry input CI in the logic high state. The transistors M1, M2, M5, M6, M11, M12, M16, and M17 are turned off due to their gates being coupled to the respective input operands A or B in the logic high state, while the transistors M18 and M19 are turned on.

In these states, the power terminal of the first inverter 102 is disconnected from the supply voltage VDD due to the turned-off transistors M1 and M2. The ground terminal of the first inverter 102 is connected to ground via the turned-on transistors M3 and M4. The output of the first inverter 102 is pulled to a logic low state through the conductive path formed by the turned-on transistors M7 and M8 connected to ground. Additionally, the inverter 102 receives the carry input CI in the logic high state and pulls this output to ground. This causes the output of the first inverter 102 (e.g., the negative carry output CB) to be in a logic low state, which is the inversion of the actual carry value of “1”.

The power terminal of the second inverter 104 is disconnected from the supply voltage VDD due to the turned-off transistors M9, M11, and M12. The ground terminal of the second inverter 104 is connected to ground via the turned-on transistors M10, M13, and M14. The output node of the second inverter 104, and the negative sum output SB of the circuit, is pulled to a logic low state (the inversion of the actual sum value of “1”). Because the second inverter 104 is disconnected from the supply voltage VDD, its output is a floating output. However, the turned-on transistors M18, M19, and M20 conduct, pulling the negative sum output SB to the logic low state grounded through their connections, representing the inversion of the actual sum value of “1”.

In some implementations, when the first input operand A is in a logic high state, the second input operand B is in a logic low state, and the carry input CI is in a logic low state, the transistors M3, M7, M13, and M18 (n-type, gates coupled to A) are turned on. The transistors M2, M6, M12, and M17 (p-type, gates coupled to A) are turned off. The transistors M1, M5, M11, and M16 (p-type, gates coupled to B) are turned on. The transistors M4, M8, M14, and M19 (n-type, gates coupled to B) are turned off. The transistors M9, M15 (p-type, gates coupled to CI) are turned on, and the transistors M10 and M20 (n-type, gates coupled to CI) are turned off.

The power terminal of the first inverter 102 is connected to the supply voltage VDD via the turned-on transistor M1. The ground terminal of the first inverter 102 is connected to ground via the turned-on transistor M3. The input of the first inverter 102 is pulled to a logic low state through the conductive path formed by the turned-on transistor M7 (n-type) connected to ground. This causes the output of the first inverter 102 to be in a logic high state, providing the negative carry output CB in the logic high state (the inversion of the actual carry value of “0”).

The input of the second inverter 104 is pulled to a logic low state via the turned-on transistor M7 (n-type). The power terminal of the second inverter 104 is disconnected from the supply voltage VDD due to the turned-off transistors M2, M6, M12, and M17. The ground terminal of the second inverter 104 is connected to ground via the turned-on transistor M13 (n-type). The output of the second inverter 104 is thereby pulled to a logic high state (the inversion of the actual sum value of “1”).

Furthering this example, if both input operands A and B were in the logic high state while the carry input CI was in the logic low state, the power terminal of the second inverter 104 would be connected to the supply voltage VDD, causing it to operate and pull the negative sum output SB to logic high (the inversion of the actual sum value of “0”). As the transistor M20 would be turned off due to the carry input CI being in the logic high state, the negative sum output SB would not be pulled to ground, as above.

In some implementations, when either the first input operand A or the second input operand B is in a logic high state while the other is in a logic low state, and the carry input CI is in a logic high state, the transistors coupled to the high operand (e.g., n-type transistors for A high or B high) turn on, connecting the ground terminal of the first inverter 102 to ground. The transistors coupled to the low operand (e.g., p-type transistors for B low or A low) turn on, connecting the power terminal of the first inverter 102 to the supply voltage VDD. This configuration pulls the output of the first inverter 102 to a logic low state, resulting in the negative carry output CB being in a logic low state (the inversion of the actual carry value “1”). The ground terminal of the second inverter 104 is connected via transistors coupled to CI (e.g., M10 or M20), while the power terminal of the second inverter 104 is connected via one of the transistors M11 or M12, depending on which input operand is in the logic low state. This activates the second inverter 104, causing the negative sum output SB to be in a logic high state (the inversion of the actual sum value “0”).

In some implementations, when either operand A or B is in a logic high state while the other is in a logic low state, and the carry input CI is in a logic low state, the transistors coupled to the low operand (e.g., p-type transistors for B low or A low) turn on, connecting the power terminals of the first inverter 102 and the second inverter 104 to the supply voltage VDD. The ground terminal of the first inverter 102 and the second inverter 104 are also connected to ground via one of the transistors M3 and M4 or M13 and 14, respectively. The first inverter 102 is activated and generates the negative carry output CB in a logic high state (the inversion of carry value “0”). The second inverter 104 is also activated, generating the negative sum output SB a logic low state (the inversion of the actual sum value “1”).

In another example, when the carry input CI is in a logic high state while the first input operand A and the second input operand B are both in a logic low state, the transistors M10 and M20 (n-type, gates coupled to CI) are turned on, while the transistors M9 and M15 (p-type, gates coupled to CI) are turned off. The power terminal of the second inverter 104 is disconnected from the supply voltage VDD due to the turned-off transistors M9, M11, and M12. The ground terminal of the second inverter 104 is connected to ground via the turned-on transistor M1. The input of the second inverter 104 is pulled to a logic low state via the conductive path formed by the turned-on transistor M10, causing its output (negative sum output SB) to be in a logic high state (the inversion of the actual sum value of “1”). The negative carry output CB of the first inverter 102 is determined by the states of the input operands A and B.

The truth table of the negative full adder circuit 100 is as follows:

| | | | Negative | Negative |
|---|---|---|---|---|
| | | Carry | Sum | Carry |
| Input | Input | Input | Output | Output |
| A | B | CI | SB | CB |
| 0 | 0 | 0 | 1 | 1 |
| 0 | 0 | 1 | 0 | 1 |
| 0 | 1 | 0 | 0 | 1 |
| 0 | 1 | 1 | 1 | 0 |
| 1 | 0 | 0 | 0 | 1 |
| 1 | 0 | 1 | 1 | 0 |
| 1 | 1 | 0 | 1 | 0 |
| 1 | 1 | 1 | 0 | 0 |

The negative full adder circuit 100 can be implemented in any suitable circuit, including any of the adder tree circuits, MAC circuits, or multiplication circuits described herein. Although the full adder circuit 100 has been described as a “negative” adder circuit (e.g., producing the logical inversions of the sum and carry values, as described herein), that the full adder circuit 100 can be adapted to include inverters to produce one or more “positive” (e.g., un-inverted) outputs. Without additional output inverters, the full adder circuit 100 can include 24 transistors (e.g., the transistors M1-M20 making twenty, with each of the inverters 102 and 104 having two transistors each, etc.).

In one example, the negative sum output SB can be provided as input to an inverter to generate a positive sum output, which reflects the actual sum value corresponding to the inputs A and B and the carry input CI. Additionally, the negative carry output CB can be provided as input to an inverter to generate a positive carry output, which reflects the actual sum value corresponding to the inputs A and B and the carry input CI. Different configurations of the negative full adder circuit 100 (including zero, one, or more additional inverters) can be implemented in various circuits as described herein. With a single output inverter, the full adder circuit 100 can include 26 transistors (e.g., the transistors M1-M20 making twenty, with each of the inverters 102 and 104 having two transistors each, and the output inverter including two transistors, etc.).

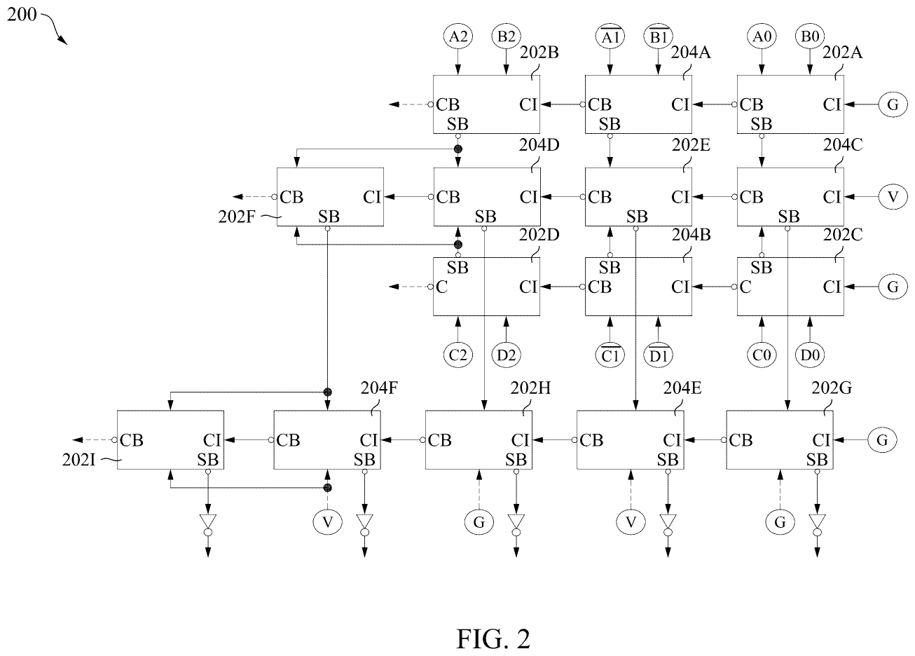

Referring to FIG. 2, illustrated is a diagram of an example adder tree circuit 200 including full adder circuits with negative outputs, in accordance with some embodiments. Each of the components shown in the adder tree circuit 200 may receive power from one or more voltage sources such as the supply voltage VDD (shown here as “V” for brevity, which can be interpreted as a logic high input for the purposes of this description). The adder tree circuit 200 may include one or more logic gates and sub-circuits, each of which may be constructed from one or more logic gates. Logic gates can be electronic devices that perform logical operations on one or more input signals to produce a single output signal.

Various embodiments of the circuits and logic gates that implement the adder tree circuit 200 may include various transistors. The transistors described herein may have a certain type (n-type or p-type), but embodiments are not limited thereto. The transistors can be any suitable type of transistor including, but not limited to, MOSFET, CMOS transistors, PMOS, NMOS, BJT, high voltage transistors, high frequency transistors, PFETs/NFETs, FinFETs, planar MOS transistors with raised source/drains, nanosheet FETs, nanowire FETs, or the like. It should be understood that the adder tree circuit 200 shown in FIG. 2 can be included in any type of circuit, including but not limited to a DCIM circuit, a MAC circuit, a multiplier circuit, or any other type of circuit implementing adder operations.

In this example, the adder tree circuit 200 is shown as including three stages, with the first stage adding the 3-bit input value A (represented in a bitwise representation as A1, A2, and A3) to the 3-bit input value B (represented in a bitwise representation as B1, B2, and B3). The first stage also includes a sum of the 3-bit input value C (represented in a bitwise representation as C1, C2, and C3) to the 3-bit input value D (represented in a bitwise representation as D1, D2, and D3).

The adder tree circuit 200 can be implemented using the full adder circuit 100 of FIG. 1. The adder tree circuit 200 is shown as including a first set of a negative full adders 202A-201I (sometimes generally referred to as “first negative full adder(s) 202”) and a second set of negative full adders 204A-204F (sometimes generally referred to as “second negative full adder(s) 204”). Each of the first negative full adders 202 and the second negative full adders 204 can include, and implement any of the functionality of, the full adder circuit 100 of FIG. 1. In doing so, the first negative full adders 202 and the second negative full adders 204 can generate logically inverted sum outputs (e.g., the negative sum output SB described herein) and logically inverted carry outputs (e.g., the negative carry output CB described herein).

In the adder tree circuit 200 of FIG. 2, due to the configuration of producing both negative sum outputs and negative carry outputs, and due to their connections with other negative adders within the circuit 200, the first negative full adders 202 receive “positive” inputs (e.g., logically un-inverted inputs), and generate “negative” outputs (e.g., logically inverted outputs). For example, the first negative full adder 202A can receive the positive inputs “1” and “0” and generate a negative output sum value of “0” (e.g., the inversion of the proper sum value of “1’) and a negative output carry value of “1” (e.g., the inversion of the proper carry value of “0”).

Additionally, due to the configuration of producing both negative sum outputs and negative carry outputs, and due to their connections with other negative adders within the circuit 200, the second negative full adders 204 receive “negative” inputs (e.g., logically inverted inputs), and generate corresponding “positive” outputs (e.g., logically un-inverted outputs). For example, the second negative full adder 204A can receive inverted inputs “0” and “1”, with an inverted carry input of “1” and generate a positive output sum value of “1” (e.g., the proper sum value of “1”, when considering that the input carry itself represents the value of “0”) and a negative output carry value of “0” (e.g., the proper carry “0”). It is noted that, while the structure of the first full adders 202 and the second full adders 204 are the same, the second full adders 204 can produce outputs that are logically un-inverted relative to the values they represent, whereas the first full adders 202 can produce outputs that retain inversion states. This difference arises because the second full adders 204 receive inverted inputs, such that their outputs revert to non-inverted logic states, while the first full adders 202 process non-inverted inputs and maintain inversion states in their outputs.

In the example implementation shown in FIG. 2, the adder tree circuit 200 can perform the summation of four 3-bit values A, B, C, and D through a hierarchical arrangement of first and second negative full adders 202 and 204. Each of the 3-bit values of A, B, C, and D are shown in FIG. 2 with a numerical identifier identifying the index of a corresponding bit. For example, A0 corresponds to the least significant bit in the value A, B2 corresponds to the most significant bit in the value B, and so on. The first stage of the adder tree circuit 200 includes the first full adders 202A-202D and the second full adders 204A-204B. From the inputs A and B, the first negative full adder 202A can receive positive inputs A0 and B0, along with a ground-level carry input (G), which represents a logic low state for the carry input (e.g., a positive carry value of zero). The second negative full adder 204A can receive inverted inputs A1 and B1 (e.g., logically negated versions of the actual values A1 and B1), along with the negative carry output generated by the first negative full adder 202A. The inverted state of the inputs A1 and B2 is visually indicated by a bar over the signal labels in FIG. 2. The second negative full adder 204B can process positive inputs A2 and B2, with the positive carry output from the second negative full adder 204A, as shown.

For the inputs C and D, the first negative full adder 202C can similarly receive positive inputs C0 and D0, along with the ground-level carry input (G). The second negative full adder 204B can receive inverted inputs C1 and D1 (the logical inversions of the actual values C1 and D1), coupled with the negative carry output from the first negative full adder 202C. The second negative full adder 204B can receive and process the positive inputs C2 and D2, with the positive carry output from the preceding second negative full adder 204B. The first stage is used to generate sums representing A+B and C+D, which are provided to the next stage in the adder tree circuit 200.

In the second stage of the adder tree circuit 200, the second negative full adder 204C can aggregate the negative sum outputs from the first negative full adders 202A and 202C in the first stage, along with a logic high carry input (V), which is an inverted signal of the actual carry value of “0.” The second negative full adder 204C can generate a positive sum output transmitted to the third stage of adders in the adder tree circuit 200, as well as a positive carry output provided to the first negative full adder 202E. The first negative full adder 202E can receive the positive sum outputs from the second negative full adders 204A and 204B in the first stage, along with the positive carry output from the second negative full adder 204C. The first negative full adder 202E can generate a negative sum output provided to the third stage and a negative carry output sent to the second negative full adder 204D.

The second negative full adder 204D can sum the negative sum outputs from the first negative full adders 202B and 202D in the first stage, along with the negative carry output from the first negative full adder 202E, to generate a positive sum output for the third stage and a positive carry output provided to the first negative full adder 202F. The first negative full adder 202F can also process the negative sum outputs from the first negative full adders 202B and 202D, alongside the positive carry output from the second negative full adder 204D, to accommodate two's complement arithmetic. The alternating structure of inverted and non-inverted inputs and outputs across the first and second negative full adders 202 and 204 enables the full circuit 200 to propagate carry signals and intermediate sums while preserving arithmetic accuracy through multiple adder stages.

The third stage of the adder tree circuit 200 serves as the final summation layer, and in this example includes the first negative full adders 202G-202H and the second negative full adders 204E-204F. The first negative full adder 202G can receive the negative sum output from the second negative full adder 204C in the second stage, along with a logic low value (G) as the second operand and a logic low carry input (G). The logic low second operand operates as a logical zero to preserve the identity of the input sum. The first negative full adder 202G can generate a negative sum output, which can be inverted using an inverter, as shown, to produce the final logically correct sum value for output. The negative carry output from the first negative full adder 202G can be provided to the second negative full adder 204E to propagate carry signals through the third stage.

The second negative full adder 204E can process the negative sum output from the first negative full adder 202E in the second stage, combined with a logic high value (V) as the second operand (acting as an inverted logical zero, effectively adding a logical zero) and the negative carry input from the first negative full adder 202G. The second negative full adder 204E can generate a positive sum output, which can be provided as part of a final output, and a positive carry output provided to the first negative full adder 202H. The first negative full adder 202H can receive the negative sum output from the second negative full adder 204D in the second stage, paired with a logic low value (G) as a second identity operand, and the positive carry input from the second negative full adder 204E. The first negative full adder 202H can generate a negative sum output, which is inverted to generate the correct (positive) final sum value and can transmit a negative carry output to the second negative full adder 204F.

The second negative full adder 204F can process the negative sum output from the first negative full adder 202F in the second stage, along with a logic high value (V) as the second operand (e.g., an identity operator), and the negative carry input from the first negative full adder 202H. The first negative full adder 204F can generate a positive sum as part of the final output, and a positive carry output provided to the first negative full adder 202I. The first negative full adder 202I can also process the negative sum output from the second negative full adder 202F in the second stage, combined with the logic high value (V) and the positive carry input from the second negative full adder 204E. The inputs of the first negative full adder 202I are the same as the second negative full adder 204F to provide compatibility with two's complement arithmetic. As shown, the first negative full adder 202I can generate a negative sum output that is inverted to form the final logically accurate result.

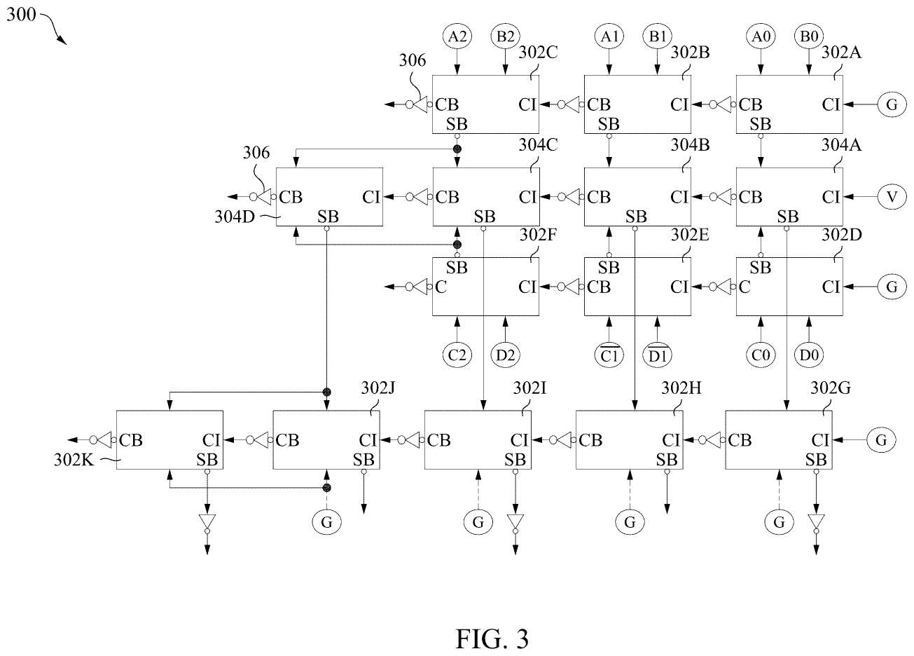

Referring to FIG. 3, illustrated is a diagram of an example adder tree circuit 300 including full adder circuits with negative sum outputs and positive carry outputs, in accordance with some embodiments. Each of the components shown in the adder tree circuit 300 may receive power from one or more voltage sources such as the supply voltage VDD (shown here as “V” for brevity, which can be interpreted as a logic high input for the purposes of this description). The adder tree circuit 300 may include one or more logic gates and sub-circuits, each of which may be constructed from one or more logic gates. Logic gates can be electronic devices that perform logical operations on one or more input signals to produce a single output signal.

Various embodiments of the circuits and logic gates that implement the adder tree circuit 300 may include various transistors. The transistors described herein may have a certain type (n-type or p-type), but embodiments are not limited thereto. The transistors can be any suitable type of transistor including, but not limited to, MOSFET, CMOS transistors, PMOS, NMOS, BJT, high voltage transistors, high frequency transistors, PFETs/NFETs, FinFETs, planar MOS transistors with raised source/drains, nanosheet FETs, nanowire FETs, or the like. It should be understood that the adder tree circuit 300 shown in FIG. 3 can be included in any type of circuit, including but not limited to a DCIM circuit, a MAC circuit, a multiplier circuit, or any other type of circuit implementing adder operations.

Similar to the example shown in FIG. 2, in this example, the adder tree circuit 300 is shown as including three stages, with the first stage adding the 3-bit input value A (represented in a bitwise representation as A1, A2, and A3) to the 3-bit input value B (represented in a bitwise representation as B1, B2, and B3). The first stage also includes a sum of the 3-bit input value C (represented in a bitwise representation as C1, C2, and C3) to the 3-bit input value D (represented in a bitwise representation as D1, D2, and D3).

Like the adder tree circuit 200 of FIG. 2, the adder tree circuit 300 can be implemented using one or more full adder circuits 100 of FIG. 1. The adder tree circuit 300 is shown as including a first set of a negative full adders 302A-302K (sometimes generally referred to as “first negative full adder(s) 302”) and a second set of negative full adders 304A-304D (sometimes generally referred to as “second negative full adder(s) 304”). Each of the first negative full adders 302 and the second negative full adders 304 can include, and implement any of the functionality of, the full adder circuit 100 of FIG. 1.

In the example shown, the first negative full adders 302 and the second negative full adders 304 can generate logically inverted sum outputs (e.g., the negative sum output SB described herein) and logically inverted carry outputs (e.g., the negative carry output CB described herein). However, the logically inverted carry outputs of both the first negative full adders 302 and the second negative full adders 304 are provided as input to respective inverters 306, such that the carry outputs of the first negative full adders 302 are positive carry outputs, and the carry outputs of the second negative full adders 304 are negative carry outputs. Note that some reference numbers for some inverters 306 are omitted in FIG. 3 for visual clarity.

In the first stage of the adder tree circuit 300, the first negative full adders 302A-302C can process the individual bits of input values A and B (e.g., A0+B0, A1+B1, A2+B2), as shown. For example, the first negative full adder 302A can receive positive inputs A0 and B0, along with a ground-level carry input (G), and generate a negative sum output (e.g., the logical inversion of the true sum) and a positive carry output (via the inverter 306 applied to its carry output). The first negative full adder 302B can similarly receive positive inputs A1 and B1, along with the positive carry output from the first negative full adder 302A via an inverter 306, to generate a negative sum output and a positive carry output. The first negative full adder 302C can process positive inputs A2 and B2, coupled with the positive carry output from the first negative full adder 302B via an inverter 306, to generate a negative sum output and a positive carry output.

The first stage of the adder tree circuit 300 is shown as including the first negative full adders 302D-302F for processing the individual bits of input values C and D (e.g., C0+D0, C1+D1, C2+D2). The first negative full adder 302D can receive positive inputs C0 and DO, along with a ground-level carry input (G), and generate a negative sum output and a positive carry output. The first negative full adder 302E can process positive inputs C1 and D1, combined with the positive carry output from the first negative full adder 302D, to produce a negative sum output and a positive carry output (via an inverter 306). The first negative full adder 302F can similarly receive positive inputs C2 and D2, along with the positive carry output from the first negative full adder 302E via an inverter 306, to generate a negative sum output and a positive carry output via an inverter 306.

In the second stage of the adder tree circuit 300, the second negative full adders 304A-304D can aggregate intermediate sums generated by the first negative full adders 302 in the first stage. The second negative full adder 304A can receive the negative sum outputs from the first negative full adders 302A and 302D, along with a logic high carry input (V), which represents an inverted logical zero. The second negative full adder 304A can generate a positive sum output (e.g., the logical inversion of the negative sum inputs combined with the inverted carry input) and a negative carry output (via the inverter 306 applied to its carry output). The second negative full adder 304B can receive the negative sum outputs from the first negative full adders 302B and 302E, coupled with the negative carry output from the second negative full adder 304A, to produce a positive sum output and a negative carry output.

The second negative full adder 304C can process the negative sum outputs from the first negative full adders 302C and 302F, along with the negative carry output from the second negative full adder 304B, to generate a positive sum output (provided to the third stage of the adder tree circuit 300) and a negative carry output via a corresponding inverter 306. The second negative full adder 304D can similarly receive the negative sum outputs from the first negative full adders 302B and 302D, combined with the negative carry output from the second negative full adder 304C, to produce a positive sum output (provided to the third stage of the adder tree circuit 300) and a negative carry output.

In the third stage, the first negative full adder 302G can receive the positive sum output from the second negative full adder 304A in the second stage, along with a ground-level value (G) as the second operand (serving as an identity operation input) and a ground-level carry input (G). The first negative full adder 302G can generate a negative sum output, which can be inverted by an inverter 306 to produce the final logically correct least significant bit of the total sum. The negative carry output from the first negative full adder 302G can be inverted by an inverter 306 to generate a positive carry signal provided to the first negative full adder 302H.

The first negative full adder 302H can receive the positive sum output from the second negative full adder 304B in the second stage, paired with a ground-level value (G) as the second operand and the positive carry input via the inverter 306 from the first negative full adder 302G. The first negative full adder 302H can generate a negative sum output, which is inverted by an inverter 306 to form the next significant bit of the final output. The negative carry output from the first negative full adder 302H can be inverted by an inverter 306 to produce a positive carry signal provided to the first negative full adder 302I.

The first negative full adder 302I can process the positive sum output from the second negative full adder 304C in the second stage, combined with a ground-level value (G) as the second operand and the positive carry input from the inverter 306 coupled to the carry output of the first negative full adder 302H. The first negative full adder 302I can generate a negative sum output, which is inverted by an inverter 306 to produce the subsequent bit of the final output. The negative carry output from the first negative full adder 302I can be inverted by an inverter 306 to generate a positive carry signal provided to the first negative full adder 302J.

The first negative full adder 302J can receive the positive sum output from the second negative full adder 304D in the second stage, along with a ground-level value (G) as the second operand and the positive carry input from the inverter 306 coupled to the carry output of the first negative full adder 302I. The first negative full adder 302J can generate a negative sum output, which is inverted by an inverter 306 to form the most significant bit of the final output. The negative carry output from the first negative full adder 302J can be inverted by an inverter 306 to propagate any remaining carry signals to higher-order bits.

The first negative full adder 302K can receive the same positive sum output from the second negative full adder 304D as the first negative full adder 302J, paired with a ground-level value (G) as the second operand and the positive carry output via an inverter 306 from the first negative full adder 302J. The first negative adder 302K receives the output to maintain compatibility with two's complement arithmetic by preserving the state of the most-significant bit for proper sign and overflow handling. The first negative full adder 302K can generate a negative sum output, which is inverted by an inverter 306 to produce the final logically accurate result for the most significant bit. The negative carry output from the first negative full adder 302K can be disregarded or maintained as part of the overflow status signal.

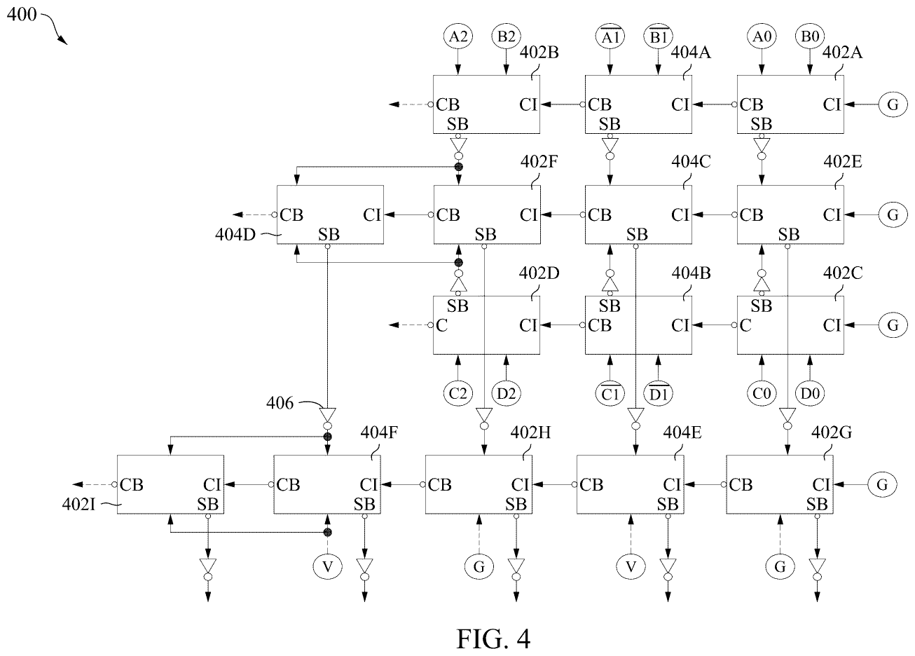

Referring to FIG. 4, illustrated is a diagram of an example adder tree circuit 400 including full adder circuits with positive sum outputs and negative carry outputs, in accordance with some embodiments. Each of the components shown in the adder tree circuit 400 may receive power from one or more voltage sources such as the supply voltage VDD (shown here as “V” for brevity, which can be interpreted as a logic high input for the purposes of this description). The adder tree circuit 400 may include one or more logic gates and sub-circuits, each of which may be constructed from one or more logic gates. Logic gates can be electronic devices that perform logical operations on one or more input signals to produce a single output signal.

Various embodiments of the circuits and logic gates that implement the adder tree circuit 400 may include various transistors. The transistors described herein may have a certain type (n-type or p-type), but embodiments are not limited thereto. The transistors can be any suitable type of transistor including, but not limited to, MOSFET, CMOS transistors, PMOS, NMOS, BJT, high voltage transistors, high frequency transistors, PFETs/NFETs, FinFETs, planar MOS transistors with raised source/drains, nanosheet FETs, nanowire FETs, or the like. It should be understood that the adder tree circuit 400 shown in FIG. 4 can be included in any type of circuit, including but not limited to a DCIM circuit, a MAC circuit, a multiplier circuit, or any other type of circuit implementing adder operations.

Similar to the example shown in FIG. 2, in this example, the adder tree circuit 400 is shown as including three stages, with the first stage adding the 3-bit input value A (represented in a bitwise representation as A1, A2, and A3) to the 3-bit input value B (represented in a bitwise representation as B1, B2, and B3). The first stage also includes a sum of the 3-bit input value C (represented in a bitwise representation as C1, C2, and C3) to the 3-bit input value D (represented in a bitwise representation as D1, D2, and D3).

Like the adder tree circuit 200 of FIG. 2, the adder tree circuit 400 can be implemented using one or more full adder circuits 100 of FIG. 1. The adder tree circuit 400 is shown as including a first set of a negative full adders 402A-402I (sometimes generally referred to as “first negative full adder(s) 402”) and a second set of negative full adders 404A-404F (sometimes generally referred to as “second negative full adder(s) 404”). Each of the first negative full adders 402 and the second negative full adders 404 can include, and implement any of the functionality of, the full adder circuit 100 of FIG. 1.

In the example shown, the first negative full adders 402 and the second negative full adders 404 can generate logically inverted carry outputs (e.g., the negative sum output SB described herein) and logically inverted carry outputs (e.g., the negative carry output CB described herein). However, the logically inverted sum outputs of both the first negative full adders 402 and the second negative full adders 404 are provided as input to respective inverters 406, such that the sum outputs of the first negative full adders 402 are positive sum outputs, and the sum outputs of the second negative full adders 404 are negative sum outputs. Note that some reference numbers for some inverters 406 are omitted in FIG. 4 for visual clarity.

In the first stage, and similar to the example arrangements described in connection with FIGS. 2 and 3, example the adder tree circuit 400 can perform the summation of four 3-bit values A, B, C, and D through a hierarchical arrangement of first and second negative full adders 402 and 404. The first stage of the adder tree circuit 400 includes the first negative full adders 402A, 402B, 402C, 402D, and the second negative full adders 404A and 404B. For the inputs A and B, the first negative full adder 402A can receive positive inputs A0 and B0, along with a ground-level carry input (G), and generate a positive sum output via the inverter 406 coupled to its output. The second negative full adder 404A can receive inverted inputs A1 and B1 (e.g., logically negated versions of the actual values A1 and B1, as represented by the bar above each value), along with the negative carry output from the first negative full adder 402A and generate a negative sum output via the inverter 406 coupled its output. The first negative full adder 402B can process positive inputs A2 and B2, along with the positive carry output from the second negative full adder 404A, to generate a negative sum output that is inverted by an inverter 406 to produce a positive sum output. The sum outputs generated by the adders 402A, 404A, and 402B are provided as operands to the second stage, as shown.

In the first stage, the inputs C and D, the first negative full adder 402C can similarly receive positive inputs C0 and D0, along with the ground-level carry input (G), and generate a negative sum output inverted by an inverter 406 to produce a positive sum output. The second negative full adder 404B can receive logical inversion of inputs C1 and D1 (designated by the bar over each value), with the negative carry output from the first negative full adder 402C and generate a negative sum output via an inverter 406 coupled to its output. The first negative full adder 402D can process positive inputs C2 and D2, with the positive carry output from the second negative full adder 404B, to generate a negative sum inverted via an inverter 406 into a positive sum output. The sum outputs generated by the adders 402C, 404B, and 402D are provided as operands to the second stage, as shown.

In the second stage, the adder tree circuit 400 includes the first negative full adders 402E and 402F, and the second negative full adders 404C and 404D. The first negative full adder 402E can receive the positive sum outputs from the first negative full adders 402A and 402C in the first stage, along with a ground-level carry input (G). The first negative full adder 402E can generate positive sum output via an inverter 406 that is provided to the third stage, as shown. The second negative full adder 404C can receive the negative sum outputs (via inverters 406) from the second negative full adders 404A and 404B in the first stage, along with the negative carry output from the first negative full adder 402E and generate a negative sum output via a corresponding inverter. The first negative full adder 402F can process the negative sum outputs (via inverters 406) from the first negative full adders 402B and 402D in the first stage, with the positive carry output from the second negative full adder 404C, to generate a positive sum value via an inverter 406. The second negative full adder 404D can receive the same negative sum outputs from the first negative full adders 402B and 402D, with the negative carry output from the first negative full adder 402F, to generate a negative sum output via an inverter. The second negative full adder 404D receives the same input as the first negative full adder 402F to maintain two's complement compatibility.

The third stage (and final stage, in this example) of the adder tree circuit 400 is shown as including the first negative full adders 402G-402I and the second negative full adders 404E-404F. The first negative full adder 402G can receive the positive sum output (via an inverter 406) from the first negative full adder 402E in the second stage, paired with a logic low value (G) as a second operand and a logic low carry input (G). The first negative full adder 402G can generate a negative sum output that is inverted by an inverter 406 to produce the final positive sum value for the least significant bit of the output. The negative carry output from the first negative full adder 402G can be provided to the second negative full adder 404E. The second negative full adder 404E can process the negative sum output from the second negative full adder 404C in the second stage, combined with a logic high value (V) as an inverted identity operand and the negative carry input from the first negative full adder 402G, to generate a positive sum output, which is the next least significant bit of the resulting output.

The first negative full adder 402H can receive the negative sum output (via an inverter 406) from the first negative full adder 402F in the second stage, along with a logic low value (G) as an identity operand, and the positive carry output from the second negative full adder 404E to generate a negative sum output inverted via an inverter 406 into a positive output bit value for the third least significant bit of the output sum. The second negative full adder 404F can process the negative sum output from the second negative full adder 404D in the second stage, paired with a logic high value (V) as an inverted identity operand and the negative carry output from the first negative full adder 402H, to generate a positive sum output, as the second most significant bit of the output sum. The first negative full adder 402I can process the same inputs as the second negative full adder 404F, similar to other arrangements described herein, to generate the most significant bit of the output sum and to maintain compatibility with two's complement.

Although the adder tree circuits 200, 300, and 400 of FIGS. 2, 3, and 4 are described as having three stages, it should be understood that each stage of the adder tree circuits 200, 300, and 400 of FIGS. 4, 5, and 6 may include any number of inputs, which may result in a greater number of stages than the three stages shown in each of FIGS. 2, 3, and 4. For example, in some implementations, an additional two-stage portion, similar to the first two-stages shown in FIGS. 2, 3, and 4, may be included, facilitating addition of four additional values. The outputs of both second stages can be combined, for example, in the third stage shown in each of FIGS. 2, 3, and 4. For example, the outputs of the additional second stage can be provided as second input operands to each of the adders in the third stage, rather than the identity inputs described herein. The output of the third stage may then be provided to a fourth stage, and so on, to combine any number of values. Additionally, although the examples described in connection with FIGS. 2, 3, and 4 are described as adding 3-bit operands, it should be noted that operands with any bit width may be accumulated using the full adder circuits 100 of FIG. 1 (or variations thereof), for example, by including additional adder circuits at each adder stage to accommodate additional bits of each operand.

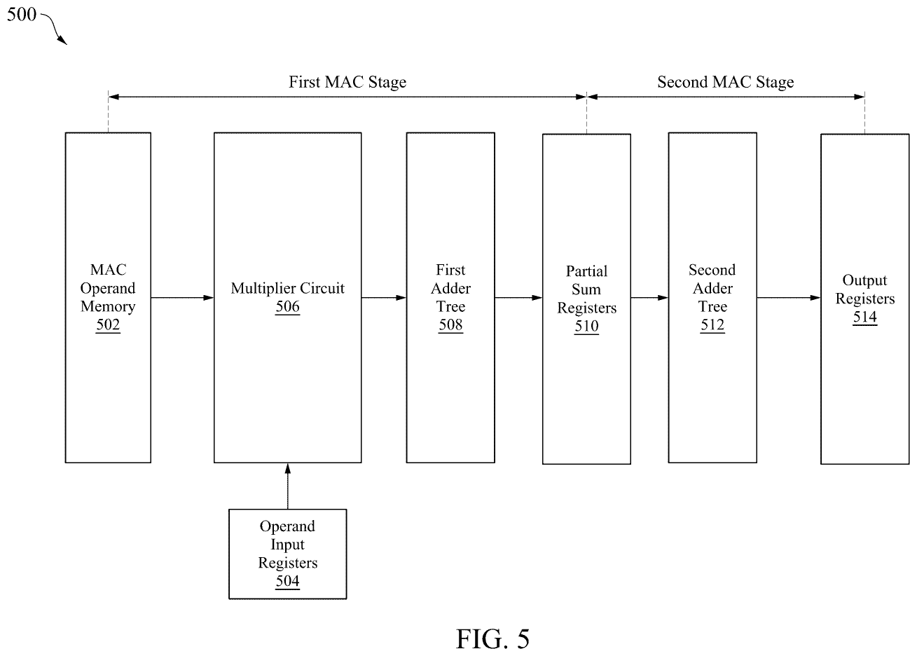

Referring to FIG. 5, illustrated is a diagram of an example MAC circuit 500 that can implement one or more of the adder tree circuits described in connection with FIGS. 2, 3, and 4, in accordance with some embodiments. Each of the components shown in the MAC circuit 500 may receive power from one or more voltage sources such as a supply voltage VDD. The MAC circuit 500 may include one or more logic gates and sub-circuits, each of which may be constructed from one or more logic gates. Logic gates can be electronic devices that perform logical operations on one or more input signals to produce a single output signal.

The MAC circuit 500 is shown as including MAC operand memory 502, operand input registers 504, a multiplier circuit 506, a first adder tree circuit 508, a set of partial sum registers 510, a second adder tree circuit 512, and a set of output registers 514. Various embodiments of the circuits and logic gates that implement the MAC circuit 500 may include various transistors. The transistors described herein may have a certain type (n-type or p-type), but embodiments are not limited thereto. The transistors can be any suitable type of transistor including, but not limited to, MOSFET, CMOS transistors, PMOS, NMOS, BJT, high voltage transistors, high frequency transistors, PFETs/NFETs, FinFETs, planar MOS transistors with raised source/drains, nanosheet FETs, nanowire FETs, or the like. It should be understood that the MAC circuit 500 shown in FIG. 5 can be included in any type of circuit, including but not limited to a DCIM circuit, a hardware accelerator circuit, a memory circuit, or any other type of circuit implementing MAC operations.

The MAC operand memory 502 can include any type of memory circuit, including but not limited to a static random-access memory (SRAM) array, a dynamic random-access memory (DRAM) circuit, or other storage medium that can store operands for MAC operations. In some implementations, the MAC operand memory 502 can organize stored data into rows and columns corresponding to dimensions of weight matrices or tensors, including but not limited to 8 bit weight value for machine-learning operations. In some implementations, the MAC operand memory 502 can provide read ports to output selected 8-bit weight values in parallel to the multiplier circuit 506, enabling simultaneous access to multiple operands during computation.

The operand input registers 504 can comprise a bank of flip-flop circuits arranged to store individual elements of an input vector. For example, the operand input registers 504 can include eight parallel 8-bit registers. In some implementations, the operand input registers 504 can align their stored 8-bit values with corresponding 8-bit weight values from the MAC operand memory 502, such that each register pair forms a multiplicand-multiplier pair for the multiplier circuit 506. In some implementations, the operand input registers 504 can include or may be coupled to multiplexers that can dynamically select input data from external memory interfaces and/or prior processing stages.

The multiplier circuit 506 can be any type of multiplier circuit that can generate products using the first operands stored in the MAC operand memory 502 and the second operands stored in the operand input registers 504. In some implementations, the multiplier circuit 506 can include an array of lookup table (LUT)-based multiplier units. The multiplier units can operate in parallel stages to improve overall multiplication performance. The partial products generated using the multiplier circuit 506 can be provided as input to the first adder tree circuit 508.

The first adder tree circuit 508 can include a hierarchical structure of full-adder stages, such as those described in connection with the adder tree circuits 200, 300, and 400 of FIGS. 2, 3, and 4. In one example, the first adder tree circuit 508 can receive a set of input partial sums of 17-bits each, then reduce them to intermediate values through a first stage of 2:1 adders. Subsequent stages can further halve the number of partial sums while increasing their bit width, such that after three stages, the outputs become 19-bit values. In some implementations, the first adder tree circuit 508 can include pipelining registers between stages to synchronize timing with clock cycles of the MAC circuit 500. The partial sum registers 510 can store the 19-bit values, for example, using a D-type flip-flop array.

The second adder tree circuit 512 can include a set of summation stages to combine the 19-bit partial sums from the partial sum registers 510. The second adder tree circuit 512 can include a hierarchical structure of full-adder stages, such as those described in connection with the adder tree circuits 200, 300, and 400 of FIGS. 2, 3, and 4. For example, the second adder tree circuit 512 can aggregate eight 19-bit values into a single 22-bit result through a two-stage process, with a first stage reducing the inputs to 20-bit terms, followed by a subsequent stage reducing the inputs to 21-bit terms, and an output stage producing a final 22-bit output. The output registers 514 can capture this using, for example one or more flip flop circuits. In some implementations, the output registers 514 can include error-detection circuits, such as parity-check bits, to validate integrity of the computed output value prior to transmission.

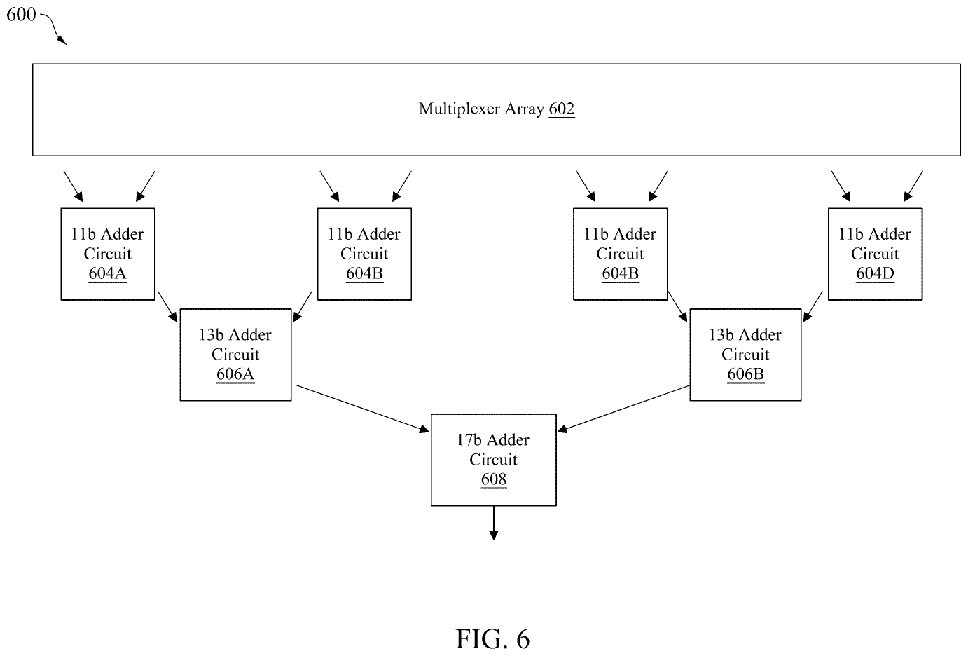

FIG. 6 illustrates a diagram of a portion of a multiplier circuit 600 that can be included in the MAC circuit 500 described in connection with FIG. 5, in accordance with some embodiments. The multiplier circuit 600 can be or include any of the structure and/or functionality of the multiplier circuit 506 of the MAC circuit 500 described in connection with FIG. 5. Each of the components shown in the multiplier circuit 600 may receive power from one or more voltage sources such as a supply voltage VDD. The multiplier circuit 600 may include one or more logic gates and sub-circuits, each of which may be constructed from one or more logic gates. Logic gates can be electronic devices that perform logical operations on one or more input signals to produce a single output signal.

The multiplier circuit 600 is shown as including a multiplexer array 602, a set of 11-bit adder circuits 604A-604D, a set of 13-bit adder circuits 606A-606B, and a 17-bit adder circuit 608. Any of the adder circuits of the multiplier circuit 600 may be implemented using any of the adder circuits described in connection with FIGS. 1, 2, 3, and 4. Various embodiments of the circuits and logic gates that implement the multiplier circuit 600 may include various transistors. The transistors described herein may have a certain type (n-type or p-type), but embodiments are not limited thereto. The transistors can be any suitable type of transistor including, but not limited to, MOSFET, CMOS transistors, PMOS, NMOS, BJT, high voltage transistors, high frequency transistors, PFETs/NFETs, FinFETs, planar MOS transistors with raised source/drains, nanosheet FETs, nanowire FETs, or the like. It should be understood that the multiplier circuit 600 shown in FIG. 6 can be included in any type of circuit, including but not limited to a DCIM circuit, a hardware accelerator circuit, a memory circuit, or any other type of circuit implementing MAC operations.

In this example, the multiplexer array 602 can provide outputs as part of the multiplier circuit 600, to generate partial sums that are accumulated using the set of 11-bit adder circuits 604A-604D, the set of 13-bit adder circuits 606A-606B, and the 17-bit adder circuit 608. In one example, the multiplexer array 602 (e.g., a MUX4 array) can provide eight 9-bit outputs. The 11-bit adder circuits 604A-604D can each accumulate a corresponding pair of 9-bit outputs from the multiplexer array 602. Each of the 11-bit adder circuits 604A-604D can implemented using one or more of the arrangements of adder circuits described in connection with FIGS. 2, 3, and 4. For example, the 11-bit adder circuits 604A-604D can include multi-stage adder tree that sums each of the outputs of the multiplexer array 602 to generate 11-bit outputs. Each of the 11-bit outputs can be provided as input to a corresponding 13b adder circuit 606A-606B, which can be provided as input to the 17-bit adder circuit 608. The 17-bit adder circuit 608 can accumulate the outputs of the 13-bit adder circuits 606A-606B to generate a 17-bit partial product output.

FIG. 6 illustrates a diagram of a portion of a multiplier circuit 600 that can be included in the MAC circuit 500 described in connection with FIG. 5, in accordance with some embodiments. The multiplier circuit 600 can be or include any of the structure and/or functionality of the multiplier circuit 506 of the MAC circuit 500 described in connection with FIG. 5. Each of the components shown in the MAC circuit 500 may receive power from one or more voltage sources such as a supply voltage VDD. The MAC circuit 500 may include one or more logic gates and sub-circuits, each of which may be constructed from one or more logic gates. Logic gates can be electronic devices that perform logical operations on one or more input signals to produce a single output signal.

The multiplier circuit 600 is shown as including a multiplexer array 602, a set of 11-bit adder circuits 604A-604D, a set of 13-bit adder circuits 606A-606B, and a 17-bit adder circuit 608. Various embodiments of the circuits and logic gates that implement the MAC circuit 500 may include various transistors. The transistors described herein may have a certain type (n-type or p-type), but embodiments are not limited thereto. The transistors can be any suitable type of transistor including, but not limited to, MOSFET, CMOS transistors, PMOS, NMOS, BJT, high voltage transistors, high frequency transistors, PFETs/NFETs, FinFETs, planar MOS transistors with raised source/drains, nanosheet FETs, nanowire FETs, or the like. It should be understood that the MAC circuit 500 shown in FIG. 5 can be included in any type of circuit, including but not limited to a DCIM circuit, a hardware accelerator circuit, a memory circuit, or any other type of circuit implementing MAC operations.

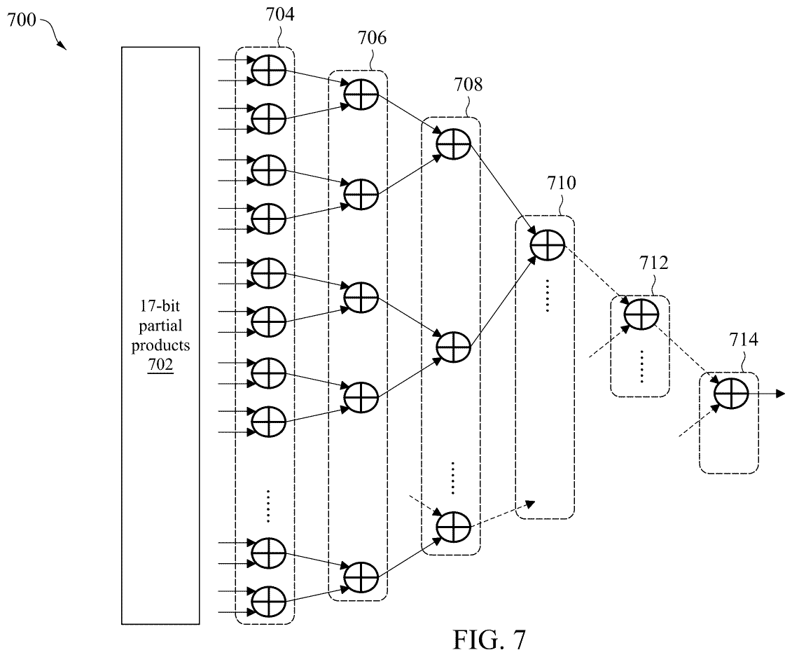

Referring to FIG. 7, illustrated is a diagram of an example adder tree circuit 700, which may encompass one or more of the adder tree circuits (e.g., the first adder tree circuit 508, the second adder tree circuit 512, etc.) of the MAC circuit 500 described in connection with FIG. 5, in accordance with some embodiments. Each of the components shown in adder tree circuit 700 may receive power from one or more voltage sources such as a supply voltage VDD. The MAC circuit 500 may include one or more logic gates and sub-circuits, each of which may be constructed from one or more logic gates. Logic gates can be electronic devices that perform logical operations on one or more input signals to produce a single output signal.

The adder tree circuit 700 is shown as including a set of 17-bit partial products 702, a set of 17-bit adder circuits 704, a set of 18-bit adder circuits 706, a set of 19-bit adder circuits 708, a set of 20-bit adder circuits 710, a set of 21-bit adder circuits 712, and a set of 22-bit adder circuits 714. Any of the adder circuits of the adder tree circuit 700 may be implemented using any of the adder circuits described in connection with FIGS. 1, 2, 3, and 4. Various embodiments of the circuits and logic gates that implement the adder tree circuit 700 may include various transistors. The transistors described herein may have a certain type (n-type or p-type), but embodiments are not limited thereto. The transistors can be any suitable type of transistor including, but not limited to, MOSFET, CMOS transistors, PMOS, NMOS, BJT, high voltage transistors, high frequency transistors, PFETs/NFETs, FinFETs, planar MOS transistors with raised source/drains, nanosheet FETs, nanowire FETs, or the like. It should be understood that the adder tree circuit 700 shown in FIG. 7 can be included in any type of circuit, including but not limited to a DCIM circuit, a hardware accelerator circuit, a memory circuit, or any other type of circuit implementing MAC operations.

The 17-bit partial products 702 can be generated, for example, by one or more of the multiplier circuits 600 of FIG. 6, which may be included as part of a MAC circuit 500 of FIG. 5. To accumulate the partial products, the adder tree circuit 700 can implement a hierarchy of multiple adder circuits. For example, any of the set of 17-bit adder circuits 704, the set of 18-bit adder circuits 706, the set of 19-bit adder circuits 708, the set of 20-bit adder circuits 710, the set of 21-bit adder circuits 712, and the set of 22-bit adder circuits 714 can be implemented using the adder tree circuits 200, 300, or 400 described in connection with FIGS. 4, 5, and 6. The output of the adder tree circuit 700 can be a 23-bit output value, which may be stored, for example, in an output register (e.g., the output register 514 of FIG. 5) as part of a 32-bit floating point value, in some implementations.

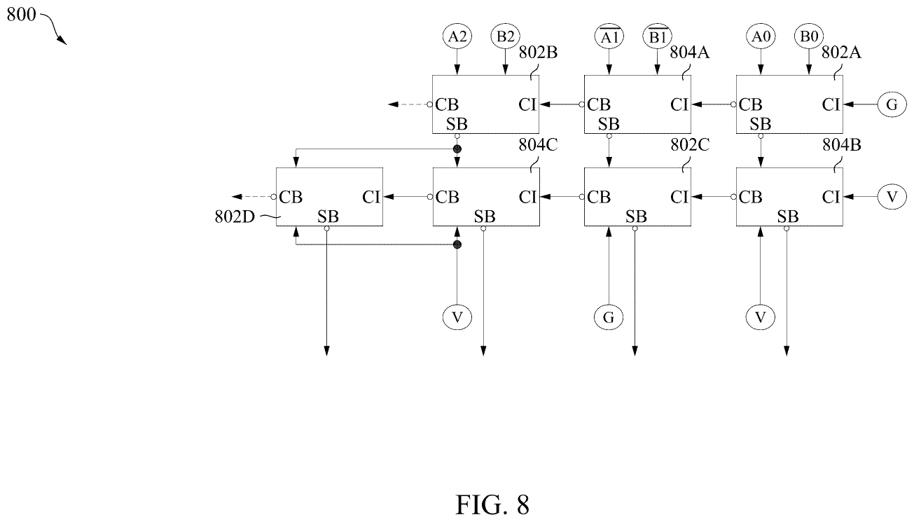

Referring to FIG. 8, illustrated is a diagram of an example two-stage adder tree circuit 800 including full adder circuits (e.g., adder tree circuits 100 of FIG. 1) with negative sum outputs and negative carry outputs, in accordance with some embodiments. Each of the components shown in the adder tree circuit 800 may receive power from one or more voltage sources such as the supply voltage VDD (shown here as “V” for brevity, which can be interpreted as a logic high input for the purposes of this description). The adder tree circuit 800 may include one or more logic gates and sub-circuits, each of which may be constructed from one or more logic gates. Logic gates can be electronic devices that perform logical operations on one or more input signals to produce a single output signal.

Various embodiments of the circuits and logic gates that implement the adder tree circuit 800 may include various transistors. The transistors described herein may have a certain type (n-type or p-type), but embodiments are not limited thereto. The transistors can be any suitable type of transistor including, but not limited to, MOSFET, CMOS transistors, PMOS, NMOS, BJT, high voltage transistors, high frequency transistors, PFETs/NFETs, FinFETs, planar MOS transistors with raised source/drains, nanosheet FETs, nanowire FETs, or the like. It should be understood that the adder tree circuit 800 shown in FIG. 8 can be included in any type of circuit, including but not limited to a DCIM circuit, a MAC circuit, a multiplier circuit, or any other type of circuit implementing adder operations.

Similar to the example shown in FIG. 2, in this example, the adder tree circuit 800 shows addition in a first stage of adding a 3-bit input value A (represented in a bitwise representation as A1, A2, and A3) to a 3-bit input value B (represented in a bitwise representation as B1, B2, and B3). The adder tree circuit 800 is shown as including a first set of a negative full adders 802A-802D (sometimes generally referred to as “first negative full adder(s) 802”) and a second set of negative full adders 804A-804C (sometimes generally referred to as “second negative full adder(s) 804”). Each of the first negative full adders 802 and the second negative full adders 804 can include, and implement any of the functionality of, the full adder circuit 100 of FIG. 1.

In the first stage, the example adder tree circuit 800 can operate similarly to the adder tree circuit 200 of FIG. 2, with the first adder 802A calculating the negative sum of A0 and B0, the second adder 804A calculating the positive output sum of negative A1 and negative B1, and the first adder 802B calculating the negative sum of A2 and B2, each of which propagate a corresponding carry value, as described in connection with FIG. 2, and providing its corresponding sum output to the second stage.

Similar to the example of FIG. 2, the example adder tree circuit 800 includes the second negative adders 804B and 804C, and the first negative adders 802C and 802D. As shown, the first negative adder 804B receives the negative sum from the first adder 802A, an identity value (e.g., shown here as “V”, or logic high, representing actual addition of zero), and a logic high carry input (representing an actual carry input of zero). The second negative adder 804B generates a least significant positive sum output, and a positive carry that propagates to the first adder 802C.

The first negative adder 802C receives the positive sum from the second adder 804A, the positive carry output of the second adder 804B, and a logic low identity input (representing an actual addition input of zero). The first negative adder 802C generates the next least significant negative sum output, and a negative carry that propagates to the second adder 804C. In some implementations, an inverter may be provided to invert the negative sum output of the first negative adder 802C to a positive output. In some implementations, the inverter may not be provided such that the negative sum output can be provided as input to a next stage in an adder tree circuit.

The second negative adder 804C receives the negative sum from the first adder 802B, the negative carry output of the first adder 802C, and a logic high identity input (representing an actual addition input of zero). The second negative adder 804C generates the next least significant positive sum output, and a positive carry that propagates to the first negative adder 802D. The first negative adder 802D receives the same negative sum from the first adder 802B, the positive carry output of the second negative adder 804C, and a logic high identity input. The first negative adder 802D generates the most significant positive sum output. The first negative adder 802D receives the same operand inputs as the second negative adder 804C to maintain two's complement compatibility, as described herein. In some implementations, an inverter may be provided to invert the negative sum output of the first negative adder 802C to a positive output. In some implementations, the inverter may not be provided such that the negative sum output can be provided as input to a next stage in an adder tree circuit.

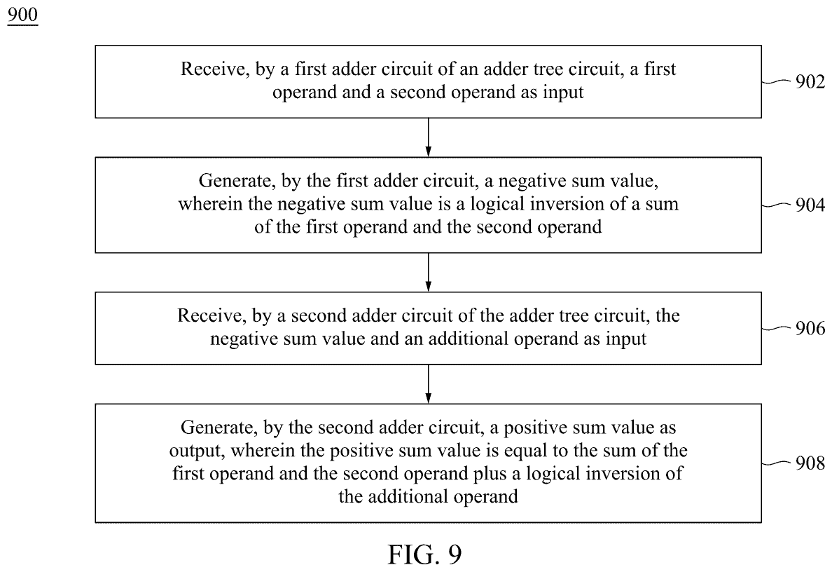

FIG. 9 illustrates a flowchart of an example method 900 of operating one or more of the adder circuits described herein. The method 900, or portions thereof, may be performed by one or more components of a computing system (e.g., the MAC circuit 500 of FIG. 5, etc.), by one or more of the adder tree circuits described herein (e.g., the adder tree circuits 200, 300, 400, 800 of FIGS. 2, 3, 4, and 8, etc.), and/or using an adder circuit (e.g., the adder circuit 100 of FIG. 1). It is noted that the method 900 is merely an example and is not intended to limit the present disclosure. Accordingly, it is understood that additional operations may be provided before, during, and after the method 900 of FIG. 9, and that some other operations may only be briefly described herein.

In brief overview, the method 900 starts with operation 902, which includes receiving by a first adder circuit of an adder tree circuit, a first operand and a second operand as input. The method 900 proceeds to operation 904, which includes generating, by the first adder circuit, a first negative sum value, where the first negative sum value is a logical inversion of the first operand and a second operand. The method 900 proceeds to operation 906, which includes receiving, by a second adder circuit of the adder tree circuit, the negative sum value and an additional operand as input. The method 900 proceeds to operation 908, which includes generating, by the second adder circuit, a positive sum value as output, where the positive sum value is equal to the sum of the first operand and the second operand plus a logical inversion of the additional operand.

Referring to operation 902, the method 900 can include receiving by a first adder circuit (e.g., the first adder 202A, etc.) of an adder tree circuit (e.g., any of the adder tree circuits 200, 300, 400, 800 of FIGS. 2, 3, 4, and 8, etc.), a first operand (e.g., A0, etc.) and a second operand (e.g., B0, etc.) as input. The first adder circuit can be a negative full adder (e.g., the first negative full adder 202A of the adder tree circuit 200) that processes logically un-inverted inputs. For example, the first operand and second operand can be individual bits of input values (e.g., A0 and B0 of values A and B, respectively) provided to the first adder circuit. The first adder circuit can also receive a carry input, such as a ground-level carry input (G). The operands may be transmitted from upstream components, such as input registers or prior stages of the adder tree circuit and may be coupled to the first adder circuit via conductive pathways or signal lines.

Referring to operation 904, the method 900 can include generating, by the first adder circuit, a first negative sum value, where the first negative sum value is a logical inversion of the first operand and a second operand. The first negative sum value can be generated by the first adder circuit using its internal logic gates and transistors (e.g., as implemented in the full adder circuit 100 of FIG. 1), as described herein. The first adder circuit can also generate a corresponding negative carry output, which may be transmitted to subsequent adder circuits in the adder tree, as described in connection with FIGS. 2, 3, 4, and 8, among others. In some implementations, the first adder circuit may include at most 24 transistors, as described in connection with FIG. 1.

Referring to operation 906, the method 900 can include receiving, by a second adder circuit of the adder tree circuit, the negative sum value and an additional operand as input. The second adder circuit can be a negative full adder (e.g., the second negative full adder 204A of the adder tree circuit 200) that processes inverted inputs. For example, the negative sum value from the first adder circuit can be provided as an input to the second adder circuit, along with an additional operand, which may be another logically inverted input (e.g., another negative sum output from another adder circuit of the adder tree, etc.). In some implementations, the additional operand may include identity operands (e.g., logic high or low values) used to preserve intermediate values during hierarchical summation. The second adder circuit can receive the inputs via conductive pathways or signal lines coupled to its input terminals, as described herein

Referring to operation 908, the method 900 can include generating, by the second adder circuit, a positive sum value as output, where the positive sum value is equal to the sum of the first operand and the second operand plus a logical inversion of the additional operand. The second adder circuit can be a negative adder circuit, and as such the negative (e.g., active low operands) can be processed according to the circuit of FIG. 1 to generate a positive (active high) output. For example, the second negative full adder can sum the negative sum value from the first adder circuit with the additional operand (e.g., another inverted sum from another carry circuit, a logic high identity signal, etc.) to generate the positive sum output. The negative adder effectively cancels the initial inversion applied by the first adder circuit, thereby yielding the correct logical sum of the original operands. The positive sum value can then be transmitted to downstream components, such as subsequent stages of the adder tree or output registers, for further processing.

In one aspect of the present disclosure, an adder tree device is disclosed. The adder tree device can include a first adder circuit configured to receive a first operand and a second operand as input and generate a negative sum value, wherein the negative sum value is a logical inversion of a sum of the first operand and the second operand. The adder tree device can further include a second adder circuit configured to receive the first negative sum value and an additional operand as input and generate a positive sum value as output, wherein the positive sum value is equal to the sum of the first operand and the second operand plus a logical inversion of the additional operand.

In another aspect of the present disclosure, a MAC circuit is disclosed. The MAC circuit can include a multiplier circuit configured to generate a plurality of partial products. The MAC circuit can further include an adder tree circuit configured to receive the plurality of partial products, generate an intermediate sum that is logically inverted relative to a first corresponding sum of at least two of the plurality of partial products, and generate an output sum based on the intermediate sum and a second operand. The output sum is logically inverted relative to a second corresponding sum of the intermediate sum and the second operand.

In yet another aspect of the present disclosure, a method is disclosed. The method can include receiving, by a first adder circuit of an adder tree circuit, a first operand and a second operand as input. The method can include generating, by the first adder circuit, a negative sum value, wherein the negative sum value is a logical inversion of a sum of the first operand and the second operand. The method can include receiving, by a second adder circuit of the adder tree circuit, the negative sum value and a second value as input. The method can include generating, by the second adder circuit, a positive sum value as output, wherein the positive sum value is equal to the sum of the first operand and the second operand plus a logical inversion of the second value.

As used herein, the terms “about” and “approximately” generally mean plus or minus 10% of the stated value. For example, about 0.5 would include 0.45 and 0.55, about 10 would include 9 to 11, about 1000 would include 900 to 1100.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

1. An adder tree device, comprising:
a first adder circuit configured to:
receive a first operand and second operand as input; and
generate a negative sum value, wherein the negative sum value is a logical inversion of a sum of the first operand and the second operand; and
a second adder circuit configured to:
receive the negative sum value and an additional operand as input; and
generate a positive sum value as output, wherein the positive sum value is equal to the sum of the first operand and the second operand plus a logical inversion of the additional operand.

2. The adder tree device of claim 1, wherein one or more of the first adder circuit or the second adder circuit comprises at most 24 transistors.

3. The adder tree device of claim 2, wherein both the first adder circuit and the second adder circuit comprise at most 24 transistors.

4. The adder tree device of claim 1, further comprising a third adder circuit configured to receive a third operand, a fourth operand, and a carry output from the first adder circuit.

5. The adder tree device of claim 4, wherein the first adder circuit and the third adder circuit are part of a first stage, and the second adder circuit is part of a second stage.

6. The adder tree device of claim 4, further comprising an inverter to receive a negative sum output generated by the first adder circuit, and wherein the third adder circuit is configured to receive the carry output via an output of the inverter.

7. The adder tree device of claim 4, wherein the first operand and the second operand are logically inverted.

8. The adder tree device of claim 1, wherein the first adder circuit is coupled to a multiplier circuit from which the first operand and the second operand are received.

9. The adder tree device of claim 1, further comprising a third adder circuit as part of a third stage and configured to receive the positive sum value as input.

10. The adder tree device of claim 9, wherein the third adder circuit is further configured to:
receive a logic low input as a second additional operand; and
generate a negative sum value as output using the second additional operand.

11. A multiply-accumulate (MAC) circuit, comprising:
a multiplier circuit configured to generate a plurality of partial products; and
an adder tree circuit configured to:
receive the plurality of partial products;
generate an intermediate sum that is logically inverted relative to a first corresponding sum of at least two of the plurality of partial products; and
generate an output sum based on the intermediate sum and a second operand, wherein the output sum is logically inverted relative to a second corresponding sum of the first intermediate sum and the second operand.

12. The MAC circuit of claim 11, wherein the multiplier circuit comprises at least one lookup table.

13. The MAC circuit of claim 11, wherein the adder tree circuit comprises a plurality of adder circuits, each adder circuit of the plurality of adder circuits comprising at most 24 transistors.

14. The MAC circuit of claim 13, wherein the intermediate sum is generated via a first adder circuit of the plurality of adder circuits, and is provided as input to a second adder circuit of the plurality of adder circuits with the second operand to generate the output sum.

15. The MAC circuit of claim 11, further comprising a second adder tree circuit configured to:
receive the output sum of the adder tree circuit; and
generate a second output sum based on the output sum.

16. The MAC circuit of claim 11, wherein the second operand is a logic high operand, and wherein the adder tree circuit is further configured to:
provide the intermediate sum as input to an adder circuit with the logic high operand; and
generate the output sum using the adder circuit.

17. The MAC circuit of claim 11, wherein the adder tree circuit is further configured to generate at least one of the intermediate sum or a carry value via an inverter at a respective output of an adder circuit.

18. A method, comprising:
receiving, by a first adder circuit of an adder tree circuit, a first operand and a second operand as input;
generating, by the first adder circuit, a negative sum value, wherein the negative sum value is a logical inversion of a sum of the first operand and the second operand;
receiving, by a second adder circuit of the adder tree circuit, the negative sum value and a second value as input; and
generating, by the second adder circuit, a positive sum value as output, wherein the positive sum value is equal to the sum of the first operand and the second operand plus a logical inversion of the second value.

19. The method of claim 18, further comprising generating, by the first adder circuit, a negative carry value, wherein the negative carry value is a logical inversion of a sum of the first operand and the second operand.

20. The method of claim 19, further comprising providing, by the first adder circuit, the negative carry value to a third adder circuit.
